(19) United States
(12) Patent Application Publication
(10) Pub. No.: US 2012/0194912 A1
(43) Pub. Date: Aug. 2, 2012

(54) OPTICAL SYSTEMS IMPLIMENTED WITH THERMALLY CONTROLLED SUB-WAVELENGTH GRATINGS

(76) Inventors: Andrei Faraon, Menlo Park, CA (US); David A. Fattal, Mountain View, CA (US); Raymond G. Beausoleil, Redmond, WA (US)

(21) Appl. No.: 13/018,018

(22) Filed: Jan. 31, 2011

(51) Int. Cl. G02B 5/18

(52) U.S. Cl. 359/573

(57) ABSTRACT

This disclosure is directed to thermally controlled optical systems. In one aspect, an optical system includes a sub-wavelength grating having a planar geometry and a grating pattern associated with a particular shape of, and direction in which, a wavefront emerges from the grating, when the grating is illuminated by a beam of light. The system includes at least one heating element separately connected to a current source. The current source to inject a current into each heating element to heat a corresponding region of the grating and produce a desired change in the shape of, and/or direction in which, the wavefront emerges from the grating.

### TECHNICAL FIELD

This disclosure is directed to optical systems, and, in particular, to sub-wavelength gratings.

### BACKGROUND

Resonant effects in dielectric gratings were identified in the early 1990's as having promising applications to free-space optical filtering and sensing. Resonant effects typically occur in sub-wavelength gratings, where the first-order diffracted mode corresponds not to freely propagating light but to a guided wave trapped in some dielectric layer. When a high-index-contrast grating is used, the guided waves are rapidly scattered and do not propagate very far laterally. As a result, the resonant feature can be considerably broadband and of high angular tolerance, which has been used to design novel types of highly reflective mirrors. Recently, sub-wavelength grating mirrors have been used to replace the top dielectric stacks in vertical-cavity surface-emitting lasers, and in novel micro-electromechanical devices. In addition to being more compact and relatively cheaper to fabricate, sub-wavelength grating mirrors also provide polarization control.

Although in recent years there have been a number of advances in sub-wavelength gratings, designers, manufacturers, and users of optical systems continue to seek grating enhancements that broaden the possible range of grating applications.

### BRIEF DESCRIPTION OF THE DRAWINGS

FIG. 1 shows an isometric view of an example optical system.

FIGS. 2A-2B show a top plan view of an example sub-wavelength grating of an optical system.

FIG. 3 shows a cross-sectional view of lines from two separate regions of an example sub-wavelength grating revealing phase changes in reflected electromagnetic waves.

FIG. 4 shows a cross-sectional view of lines from two separate regions of an example sub-wavelength grating revealing phase changes in a reflected wavefront.

FIG. 5 shows an isometric view of an example reflected contour map produced by a sub-wavelength grating.

FIG. 6 shows a cross-sectional view of lines from two separate regions of an example sub-wavelength grating revealing phase changes in transmitted electromagnetic waves.

FIG. 7 shows a cross-sectional view of lines from two separate regions of an example sub-wavelength grating revealing phase changes in a transmitted wavefront.

FIG. 8 shows an isometric view of an example transmitted contour map produced by a sub-wavelength grating of an optical system.

FIGS. 9A-9C show a top plan views of three example one-dimensional sub-wavelength gratings.

FIGS. 10A-10B show top plan views of two example two-dimensional sub-wavelength gratings.

FIG. 11 shows an example plot of an approximation of an effective refractive index as a function of temperature for a sub-wavelength grating material.

FIG. 12 shows an example plot of temperature and index of refraction along a line that lies in the plane of a sub-wavelength grating.

FIGS. 13A-13C show views of an example thermally controlled optical system.

FIG. 13D shows an example plot of temperature and index of refraction versus distance across a sub-wavelength grating with a single heating element.

FIGS. 14A-14B show views of an example thermally controlled optical system.

FIG. 14C shows an example plot of temperature and index of refraction versus distance across a sub-wavelength grating with a plurality of heating elements.

FIGS. 15A-15C show views of an example thermally controlled optical system with a one-dimensional sub-wavelength grating.

FIGS. 16A-16C show views of an example thermally controlled optical system with a two-dimensional sub-wavelength grating.

FIG. 17 shows an isometric view of example reflected contour maps produced by a thermally controlled sub-wavelength grating.

FIGS. 18A-18B show side views of two examples of thermally controlled optical systems operated to steer reflected and transmitted beams of light.

FIGS. 19A-19B show side views of two examples of thermally controlled optical systems operated to change the focal point of reflected and transmitted beams of light.

### DETAILED DESCRIPTION

This disclosure is directed to optical systems that include a planar, sub-wavelength grating (“SWG”) and at least one heating element. Thermally controlled SWGs provide dynamic wavefront control of reflected or transmitted light. This can be accomplished by configuring the SWG with a grating pattern to produce a particular phase front that translates into a corresponding transmitted or reflected wavefront output from an optical system. The at least one heating element enables dynamic control of the phase front produced by the SWG resulting in dynamic changes in the shape and direction of the transmitted or reflected wavefronts.

In the following description, the term “light” refers to electromagnetic radiation with wavelengths in the visible and non-visible portions of the electromagnetic spectrum, including infrared and ultra-violet portions of the electromagnetic spectrum.

### Planar Sub-Wavelength Gratings

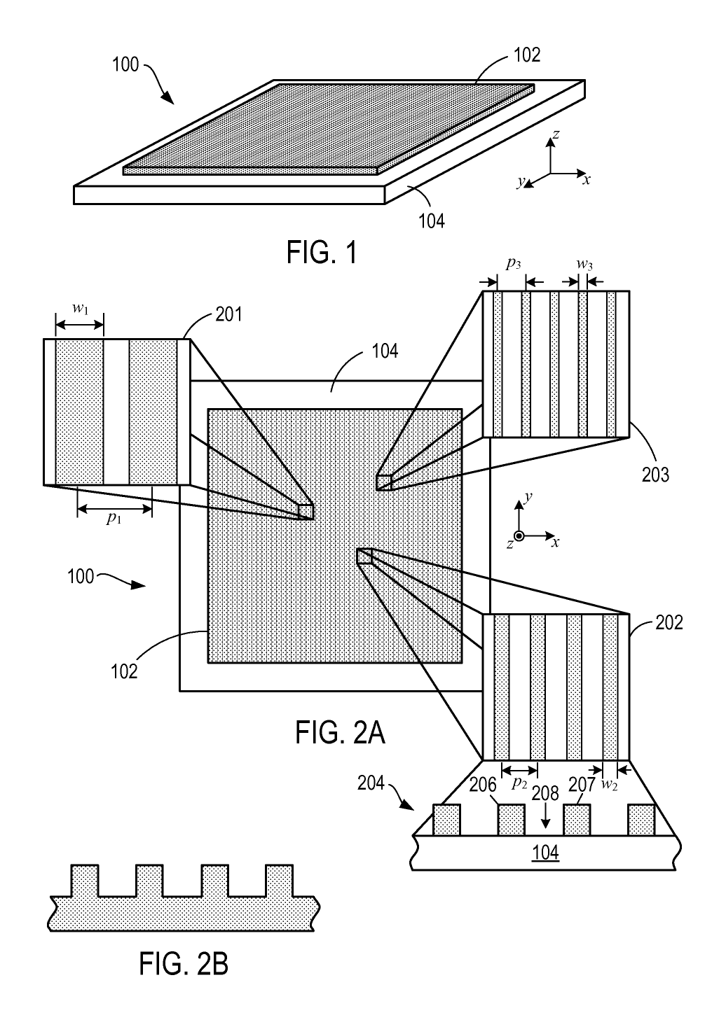

FIG. 1 shows an isometric view of an example optical system 100 that can be configured to either reflect or transmit light with a particular wavefront. The system 100 includes a planar, sub-wavelength, grating (“SWG”) 102 disposed on a surface of a substrate 104, where the SWG 102 is composed of a relatively higher refractive index material than the substrate 104. For example, the SWG 102 can be composed of silicon (“Si”) and the substrate 104 can be composed of quartz or silicon dioxide (“SiO₂”), or the SWG 102 can be composed of gallium arsenide (“GaAs”) and the substrate 104 can be composed of aluminum gallium arsenide (“AlGaAs”) or aluminum oxide (“Al₂O₃”). As shown in the example of FIG. 1, the system 100 has a planar geometry, but the SWG 102 can be configured with a particular grating pattern that enables the system 100 to be operated in the same manner as non-planar optical systems, such as spherical or cylindrical mirrors or lens.

Reflectance or transmittance properties of the system 100 are determined by the pattern of the SWG 102. FIG. 2A shows a top plan view of a SWG 102 of the system 100. In the example of FIG. 2A, three exemplary regions 201-203 of the SWG 102 are magnified. Each region comprises a number of regularly spaced wire-like portions of the SWG 102 material called “lines.” The lines extend in the y-direction and are periodically spaced in the x-direction. FIG. 2A also includes a magnified end-on view 204 of the grating region 202, which represents a strong or high-contrast SWG. A strong SWG has a relatively high contrast between the refractive index of the lines and the refractive index of the substrate 104. Shaded rectangles 206 and 207 represent lines composed of a relatively higher index material than the substrate 104. The lines 206 and 207 are separated by a groove 208 extending the length of the grating in the y-direction and expose the surface of the substrate 104. The lines 206 and 207 can be formed by etching grooves 208 that expose portions of the substrate 104. On the other hand, FIG. 2B shows an end-on view of the region 202 configured as a weak or low-contrast SWG, which has a relatively low or no contrast between the refractive index of the lines and the refractive index of the grooves. For example, in the end-on view of FIG. 2B, the lines and grooves are formed by shallow etching a layer of material.

Each of the regions 201-203 is characterized by a particular periodic spacing of the lines, p, and by the line width, w, in the x-direction. For example, the region 201 comprises lines of width w₁ separated by a period p₁, the region 202 comprises lines with width w₂ separated by a period p₂, and the region 203 comprises lines with width w₃ separated by a period p₃, where p₁>p₂>p₃ and w₁>w₂>w₃. In this case, the SWG 102 is referred to as an “non-periodic” SWG. On the other hand, when the SWG 102 is configured with the same period spacing (e.g., p₁=p₂=p₃) and the same line widths (e.g., w₁=w₂=w₃) throughout, the SWG 102 is referred to as a “periodic” SWG.

The SWG 102 is referred to as one-dimensional because the lines extend in one direction, and the SWG 102 is referred to as a sub-wavelength grating because the line widths, w, and period, p, are less than the wavelength of the light 2 for which the grating is configured to interact. For example, the lines widths can range from approximately 10 nm to approximately 300 nm and the periods can range from approximately 20 nm to approximately 1 μm depending on the wavelength of the incident light. The light reflected from a region acquires a phase φ determined by the line thickness t and the duty cycle η=w/p.

Incident light on the SWG 102 can be decomposed into a TM-polarization component and a TE-polarization component. TE polarization refers to light polarized with the electric field component directed parallel to the lines of the grating 102, and TM polarization refers to light polarized with the electric field component directed perpendicular to the lines of the grating. Although a one-dimensional SWG 102 preferentially reflects the TM-polarization component with high reflectivity, the one dimensional system 100 can be configured to also reflect the TE-polarization component. For example, a SWG with a particular duty cycle and line thickness may be suitable for reflecting the TM-polarization component but not the TE-polarization component, while a SWG with a different duty cycle and line thickness may be suitable for reflecting both TE- and TM-polarization components.

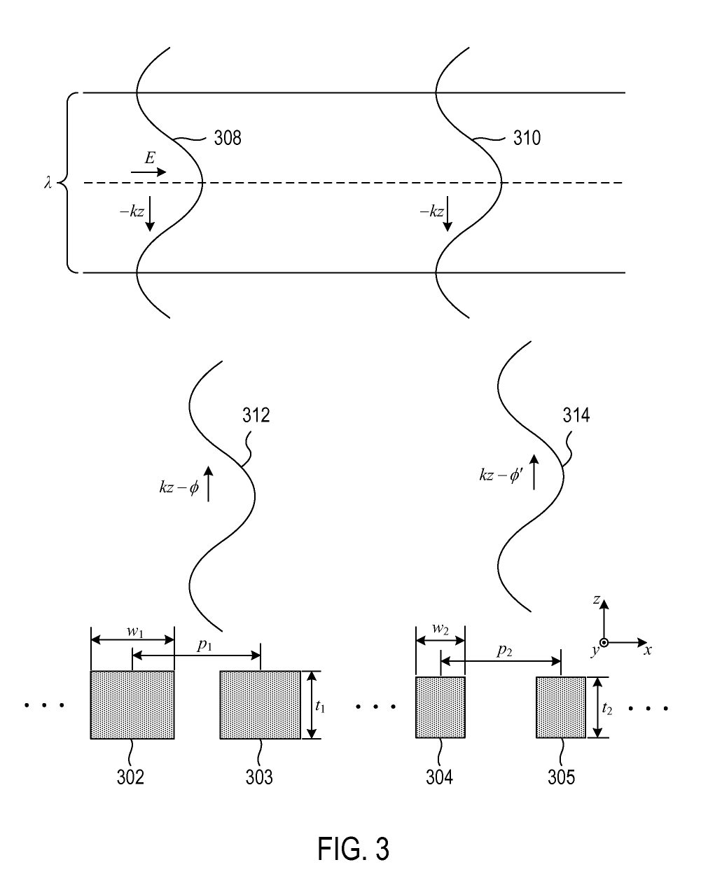

The grating regions, such as grating regions 201-203, can be configured to reflect incident light differently by appropriately selecting to the line thicknesses and duty cycles within the sub-regions. FIG. 3 shows a cross-sectional view of lines from two separate regions of an example sub-wavelength grating revealing phase changes in reflected electromagnetic waves. Lines 302 and 303 can be lines in a first region and lines 304 and 305 can be lines in a second region located elsewhere within the same SWG. The thickness t₁ of the lines 302 and 303 is greater than the thickness t₂ of the lines 304 and 305, and the duty cycle η₁ associated with the lines 302 and 303 is also greater than the duty cycle η₂ associated with the lines 304 and 305. As shown in the example of FIG. 3, the incident electromagnetic waves 308 and 310 strike the lines 302-305 with approximately the same phase. Waves incident on the lines 302 and 303 become trapped by the lines 302 and 303 and acquire a phase shift, φ, as represented by reflected electromagnetic wave 312. On the other, the thickness and duty cycle of the lines 304 and 305 is selected so that the waves incident on the lines 304 and 305 is reflected with a smaller phase shift φ′(i.e., φ>φ′), as represented by reflected electromagnetic wave 314.

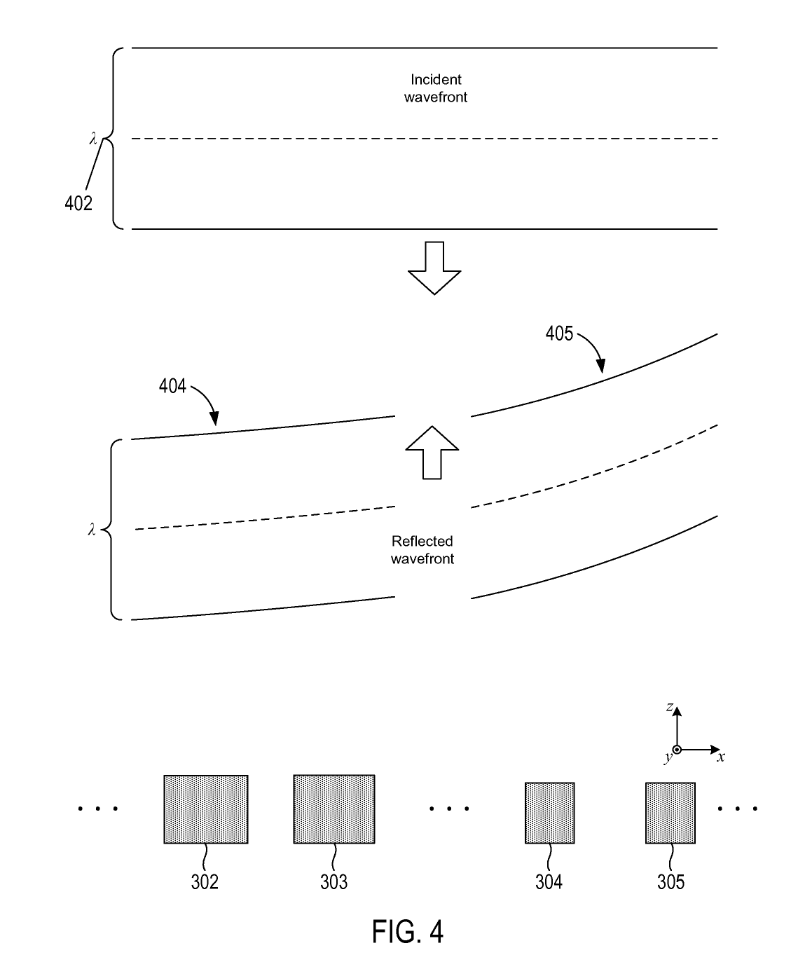

FIG. 4 shows a cross-sectional view of lines from two separate regions of an example sub-wavelength grating revealing phase changes in a reflected wavefront. In the example of FIG. 4, incident light, with an approximately uniform wavefront 402, strikes the lines 302-305 producing curved reflected wavefronts 404 and 405. The curved reflected wavefront 404 results from portions of the incident wavefront 402 interacting with the lines 302 and 303 with a relatively larger duty cycle η₁ and thickness t₁ than portions of the same incident wavefront 402 interacting with the lines 304 and 305 with a relatively smaller duty cycle η₂ and thickness t₂. The curved shapes of the reflected wavefronts 404 and 405 are consistent with the larger phase acquired by light striking the lines 302 and 303 relative to the smaller phase acquired by light striking the lines 304 and 305.

The SWG 102 can be configured to apply a particular phase change to reflected light while maintaining a high reflectance over certain regions of the SWG 102.

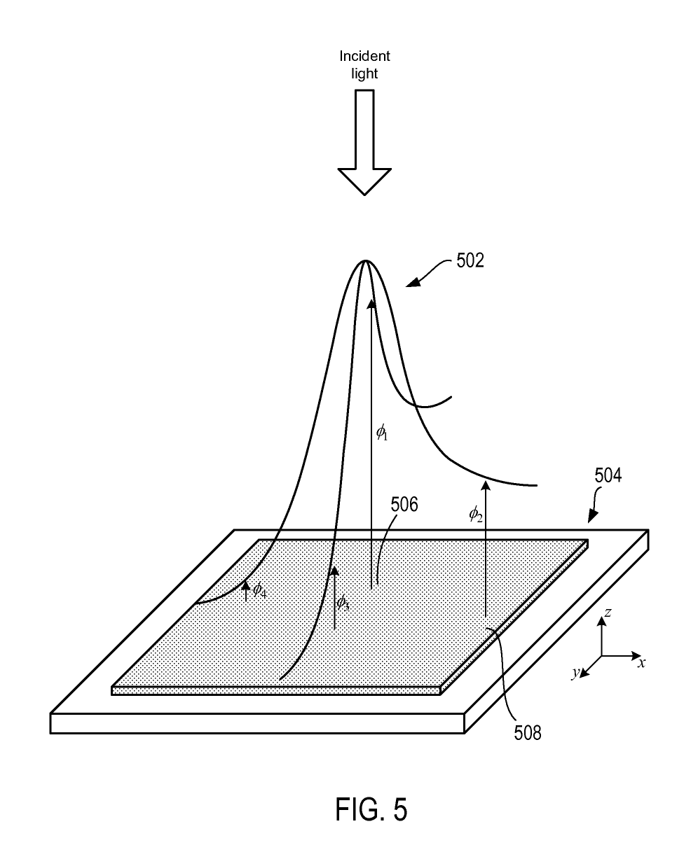

FIG. 5 shows an isometric view of an example reflective contour map 502. The SWG 504 is configured to reflect incident light with phases represented by the phase contour map 502. The grating pattern in the SWG 504 produces the largest magnitude in the phase acquired by the reflected light near the center of the SWG 504. The magnitude of the phase acquired by reflected light decreases away from the center of the SWG 504. For example, light reflected from a region 506 acquires a phase φ₁, and light reflected from a region 508 acquires a phase φ₂ , where φ₁ is greater than φ₂.

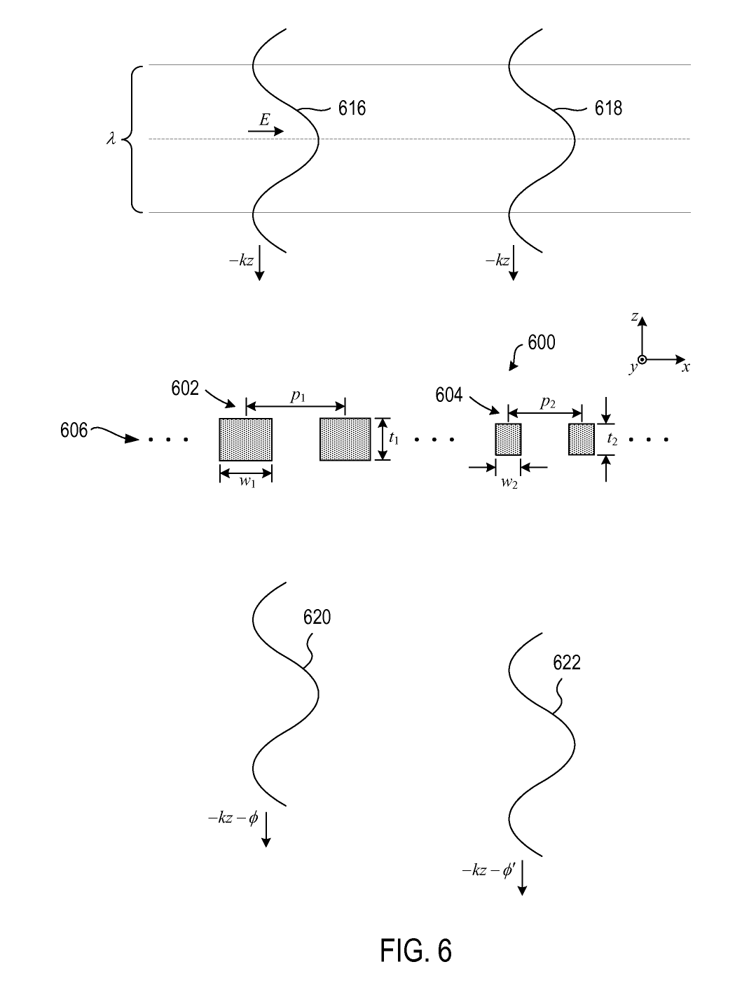

SWGs can also be configured to transmit light with a particular wavefront shape by appropriately selecting the duty cycle, line thickness, and refractive index of the material. FIG. 6 shows a cross-sectional view of an optical system 600 revealing portions of two separate grating sub-patterns 602 and 604 of a SWG 606. For example, the sub-patterns 602 and 604 can be located in different regions of the SWG 600. The thickness t₁ of the lines of sub-pattern 602 are greater than the thickness t₂ of the lines of sub-pattern 604, and the duty cycle η₁ associated with the lines in sub-pattern 602 is greater than the duty cycle η₂ associated with the lines of sub-pattern 604. TM polarized electromagnetic waves incident on the optical system 600 are transmitted through the SWG 606. As shown in the example of FIG. 6, the incident waves 616 and 618 strike the optical system 600 with approximately the same phase, but the wave 620 is transmitted through the sub-pattern 602 acquires a relatively larger phase shift φ than the phase shift φ′ (i.e., φ>φ′) acquired by the wave 622 transmitted through the sub-pattern 604.

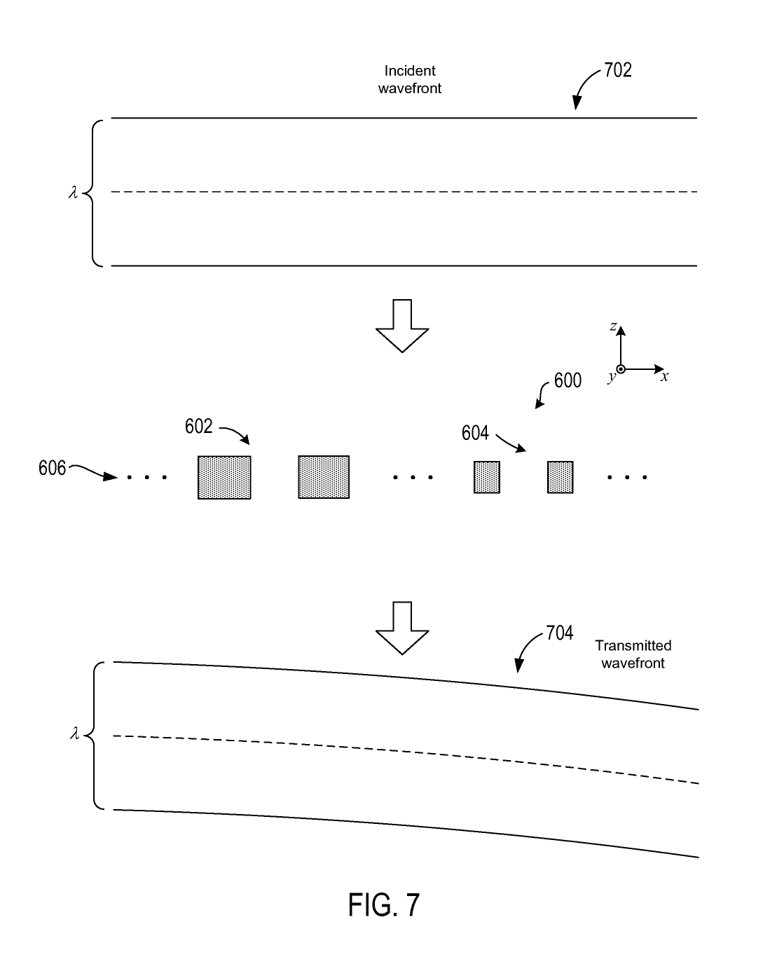

FIG. 7 shows a cross-sectional view of the optical system 600 revealing how a transmitted wavefront can be changed. As shown in the example of FIG. 7, incident light with a substantially uniform incident wavefront 702 strikes the optical system 600 producing a curved transmitted wavefront 704. The curved transmitted wavefront 704 results from portions of the incident wavefront 702 interacting with the sub-region 602 with a relatively larger duty cycle η₁ and thickness t₁ than portions of the same incident wavefront 702 interacting with the sub-region 604 with a relatively smaller duty cycle η₂ and thickness t₂.

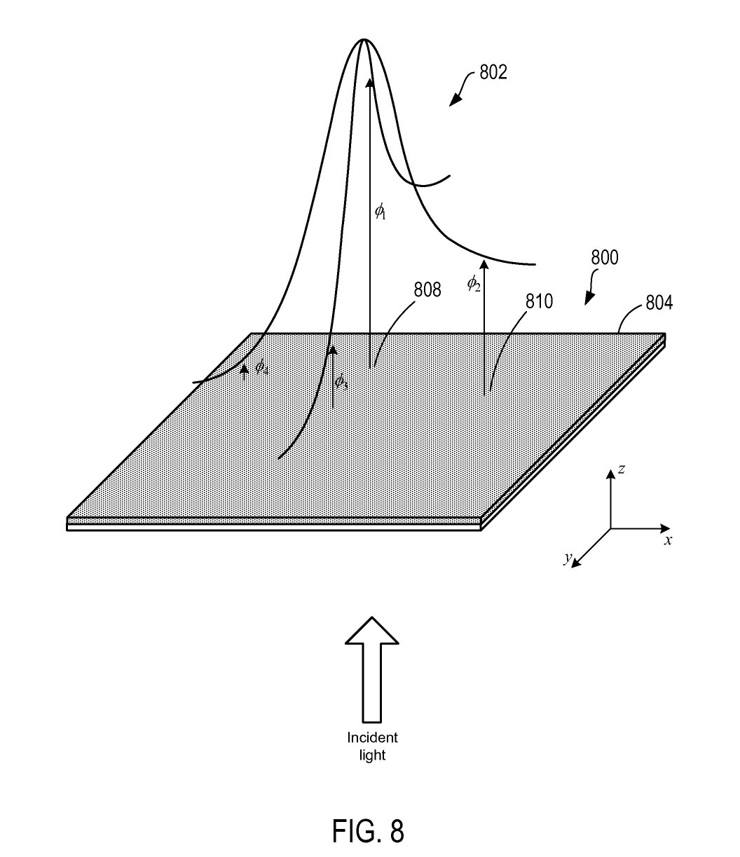

FIG. 8 shows an isometric view of an example transmissive contour map 802 produced by a particular grating pattern of an optical system 800. In the example shown in FIG. 8, the grating pattern in SWG 804 produces a tilted Gaussian-shaped transmissive phase contour map 802 with the largest magnitude in the phase acquired by light transmitted near the center of the optical system 800, and is analogous to the reflective phase front contour map 502 described above with reference to FIG. 5. The magnitude of the phase acquired by transmitted light decreases away from the center of the optical system 800. For example, light transmitted near the center 808 of the optical system 800 acquires a phase of φ₁ and light transmitted through the region 810 acquires a phase of φ₂. Because φ₁ is larger than φ₂, the light transmitted through the center 808 acquires a larger phase than the light transmitted through the region 810.

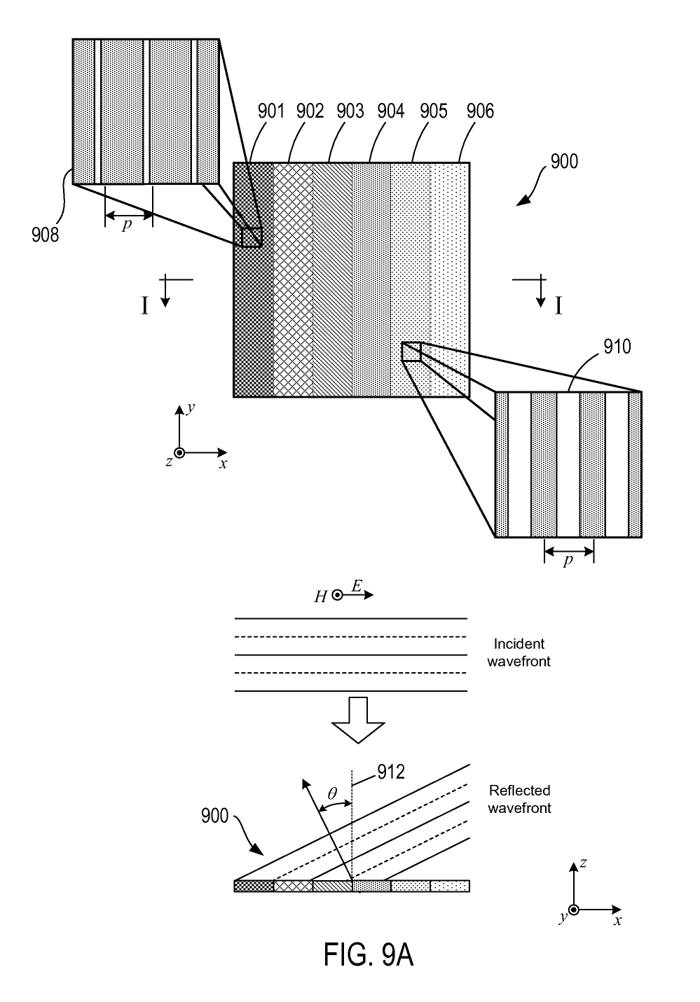

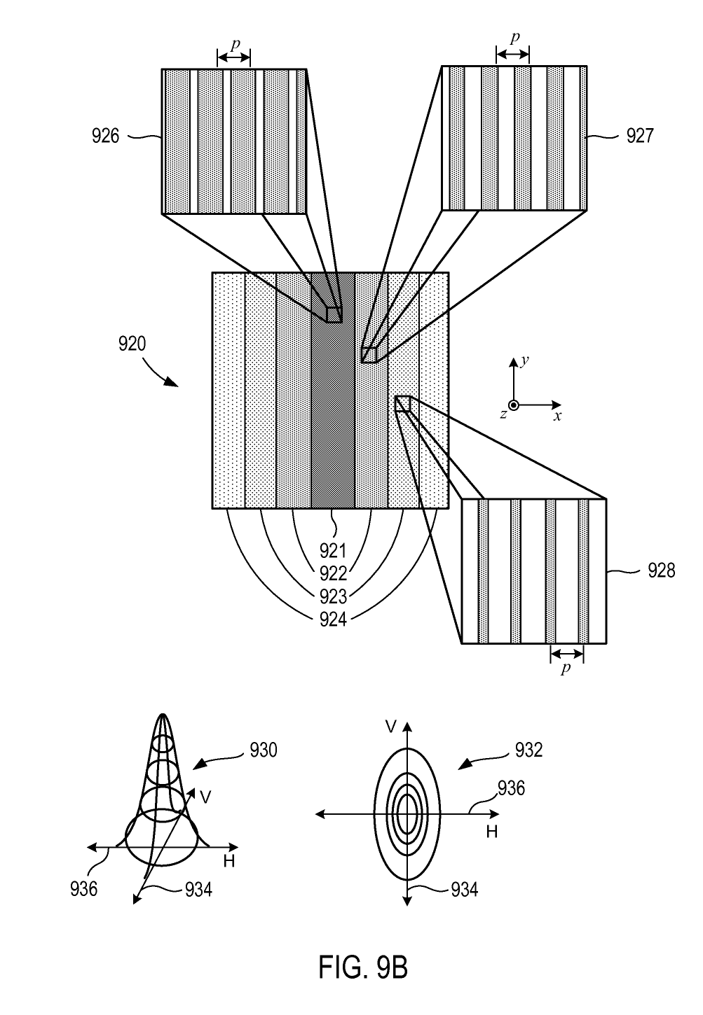

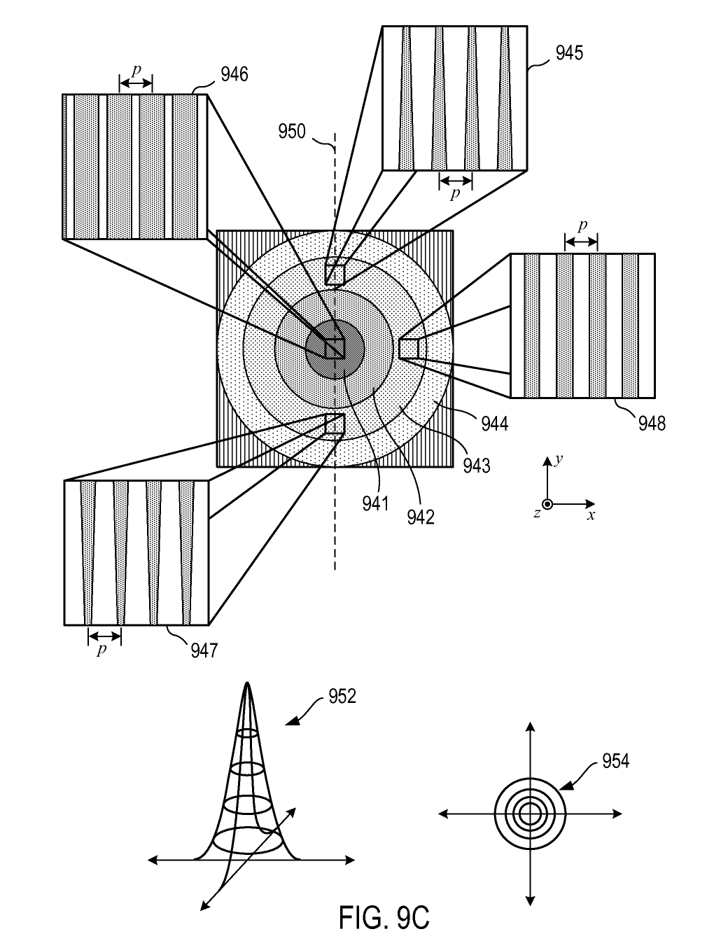

A SWG can be a non-periodic grating pattern to control of the direction and shape of a reflected or a transmitted wavefront. Examples of one-dimensional SWG patterns are now described with reference to FIGS. 9A-9C. For the sake of brevity only three SWG patterns are described, but these three patterns are not intended to exhaustive of the nearly limitless grating patterns that can be formed in a SWG.

FIG. 9A shows a top plan view of an example SWG 900 configured to reflect or transmit normal incidence TM polarized light with a non-zero angle of reflectance θ. The SWG 900 is represented by shaded regions 901-906, each region formed from lines extending in the y-direction with the same period, but with the duty cycle progressively decreasing from the region 901 to the region 906. Magnified views 908 and 910 show sub-regions of regions 901 and 904 with the same period p, but region 901 has a relatively larger duty cycle than region 904. The duty cycles for the regions 901-906 are selected so that the resulting phase change acquired by the reflected light decreases linearly from the region 901 to the region 906. FIG. 9A includes a cross-sectional view of the SWG 900 along a line I-I. The phase change causes incident TM polarized light directed normal to the grating to be reflected with an angle of reflection θ away from the surface normal 912. Note that the SWG 900 can also be configured to transmit light with a particular angle of transmission.

SWGs can also be configured to operate as a converging cylindrical mirror or lens with a constant period and variable duty cycle. FIG. 9B shows a top plan view of an example SWG 920 configured to operate as focusing cylindrical mirror or lens for incident TM polarized light. The SWG 920 is represented by shaded regions 921-924, each region represent lines extending in the y-direction with different duty cycles represented by shaded regions. For example, darker shaded regions represent regions with a relatively larger duty cycle than lighter shaded regions. FIG. 9B also includes magnified views 926-928 of sub-regions revealing that the lines are parallel in the y-direction and the duty cycle η decreases away from the center of the SWG 920. The SWG 920 is configured to operate as a cylindrical mirror or lens by focusing reflected light TM polarized to a focal point. FIG. 9B also includes example isometric and top view contour plots 930 and 932 of reflected or transmitted beam profiles at the foci. V-axis 934 is parallel to the y-direction and represents the vertical component of a reflected or transmitted beam, and H-axis 936 is parallel to the x-direction and represents the horizontal component of the reflected or transmitted beam. The reflected beam profiles 930 and 932 indicate that for incident TM polarized light, the system 920 reflects a Gaussian-shaped beam that is narrower in the direction perpendicular to the lines (the “H” or x-direction) than in the direction parallel to the lines (the “V” or y-direction).

SWGs can also be configured to operate as a converging spherical mirror or lens for incident TM polarized light by tapering the lines of the SWG. FIG. 9C shows a top plan view of an example SWG 940 configured to operate as a focusing spherical mirror or lens for incident TM polarized light. The SWG 940 is represented by annular shaded regions 941-944 that define a circular mirror aperture. Magnified views 945-948 reveal that the lines are tapered in the y-direction with a constant line period spacing p in the x-direction. In particular, magnified views 945-947 show portions of the same set of lines extending the y-direction along dashed-reference line 950. Each annular region has the same duty cycle η throughout. As a result, each portion of an annular region imparts the same approximate phase shift to the light reflected or transmitted. For example, light reflected from anywhere within the annular region 943 acquires substantially the same phase shift. FIG. 9C also includes example isometric and top view contour plots 952 and 954 of reflected or transmitted beam profiles at the foci of the SWG 940. The beam profiles 952 and 954 reveal that the SWG 940 produces a symmetrical Gaussian-shaped reflected or transmitted beam.

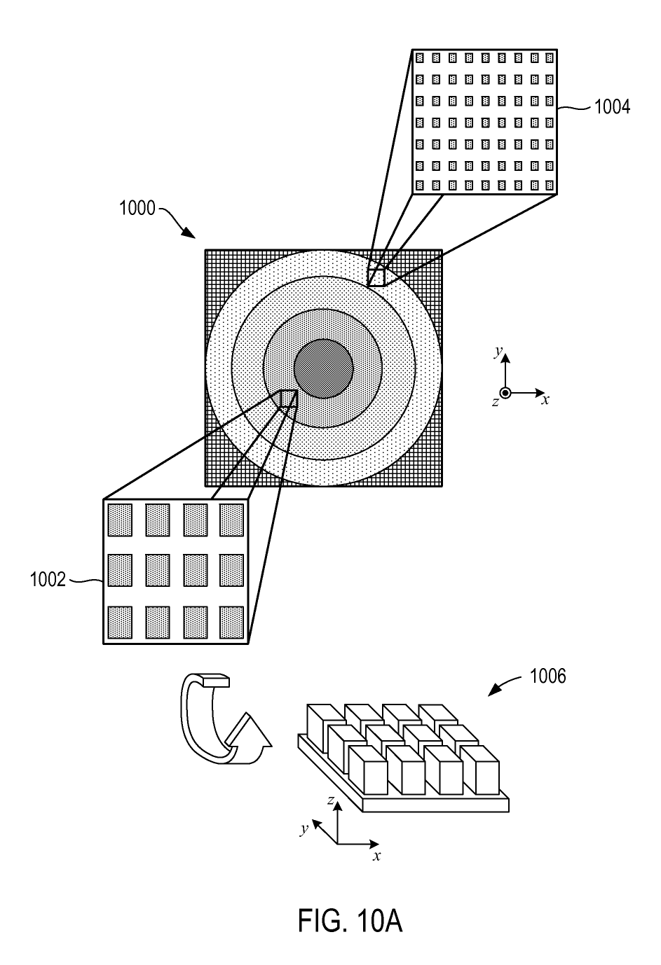

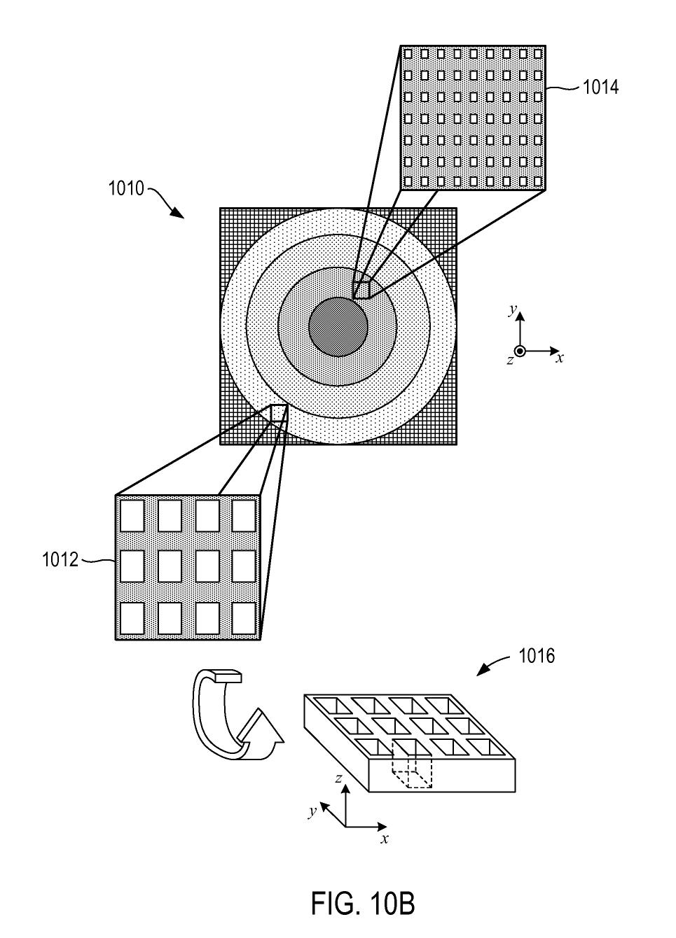

Examples of two-dimensional SWG patterns configured to operate as converging spherical mirrors or lenses are now described with reference to FIGS. 10A-10B. For the sake of brevity only two SWG patterns are described, but these two patterns are not intended to exhaustive of the nearly limitless grating patterns that can be formed in a SWG. In the example of FIG. 10A, an example two-dimensional SWG 1000 is composed of rectangular-shaped posts separated by grooves. The duty cycle and period can be varied in the x- and y-directions. Magnified views 1002 and 1004 show two different rectangular-shaped post sizes. FIG. 10A includes an isometric view 1006 of the posts in magnified view 1002. Alternatively, the posts can be square, circular, elliptical or any other suitable shape. In the example of FIG. 10B, an example two-dimensional SWG 1010 is composed of rectangular-shaped holes in a high refractive index material. Magnified views 1012 and 1014 show two different rectangular-shaped hole sizes. The duty cycle can be varied in the x- and y-directions. FIG. 10B includes an isometric view 1016 of the magnified view 1012. Alternatively, the holes can be square, circular, elliptical or any other suitable shape.

Note that one- and two-dimensional SWGs described above can also be configured to operate as diverging cylindrical and spherical mirrors or lens by reversing the duty cycles of the regions of the SWGs.

Techniques for designing and fabricating one- and two-dimensional SWGs are described in Hewlett-Packard U.S. Patent Application No. PCT/US/2009/051026, filed Jul. 17, 2009, and in “Flat Dielectric Grating Reflectors with High Focusing Power,” by D. Fattal et al., Nature Photonics, 4, 466-470, May 2010, which are herein incorporated by reference. Techniques for designing and fabricating transmissive optical systems incorporating one- and two-dimensional SWGs are described in Hewlett-Packard U.S. Patent Application No. PCT/US/2009/058006, filed Sep. 23, 2009, which is herein incorporated by reference.

### Thermally Controlled Optical Systems

The effective refractive index, n, of a SWG material varies in a nearly linearly manner with respected to the temperature of the SWG and can be approximated by the linear temperature coefficient:

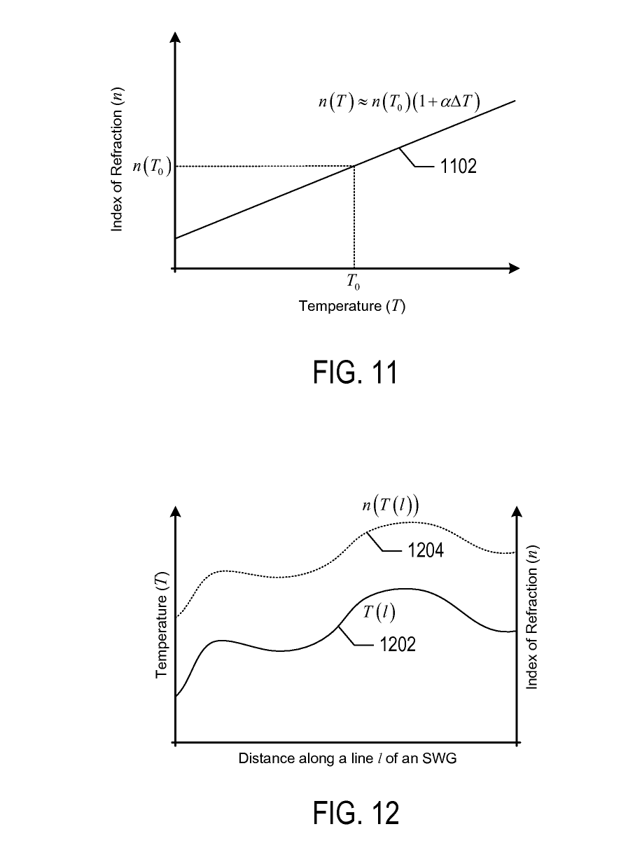

n(T)≈n(T₀)(1+αΔT)

where T₀ represents a reference temperature, T represents the temperature of the SWG, a represents the linear temperature coefficient (i.e., dn/dT), and ΔT=T−T₀. FIG. 11 shows an example plot of the effective refractive index n linear dependence on the temperature T. Line 1102 indicates that as the temperature T of an SWG increases, the effective refractive index n increases.

A change in the effective refractive index of a particular region of a SWG causes a corresponding change in the phase of the light reflected from the region. In order to dynamically control the phase of the light refracted from selected regions of a SWG, optical systems include at least one heating element so that selected regions of the SWG can be heated accordingly in order to apply a particular phase to the reflected light. FIG. 12 shows an example plot of temperature and index of refraction along a line l that lies in the xy-plane of a SWG. Curve 1202 represents the temperature T along the line l, and curve 1204 represents a corresponding variation in the index of refraction n along the same line l. Curves 1202 and 1204 reveal that as the temperature varies along the line l, the effective index of refraction of the SWG correspondingly varies.

In addition to changes in the effective refractive index of the SWG material, changes in the temperature of an SWG may also change the volume of the SWG and volume of the SWG features. In particular, an increase in temperature may increase the line width and thickness and shrink the grooves in a one-dimensional grating pattern or increase the dimensions of posts, or shrink the dimensions of holes, in a two-dimensional SWG. The change in dimensions of the grating and grating features can be determined by the thermal expansion coefficient of the SWG material and the Poisson ratio, which relates changes in size of an object along different axes and is the ratio of the contraction to expansion along an axes. Changes in the SWG volume and volume of grating features, such as line widths and thicknesses, post, and hole dimensions, have a direct effect on the phase shift acquired by reflected or transmitted light.

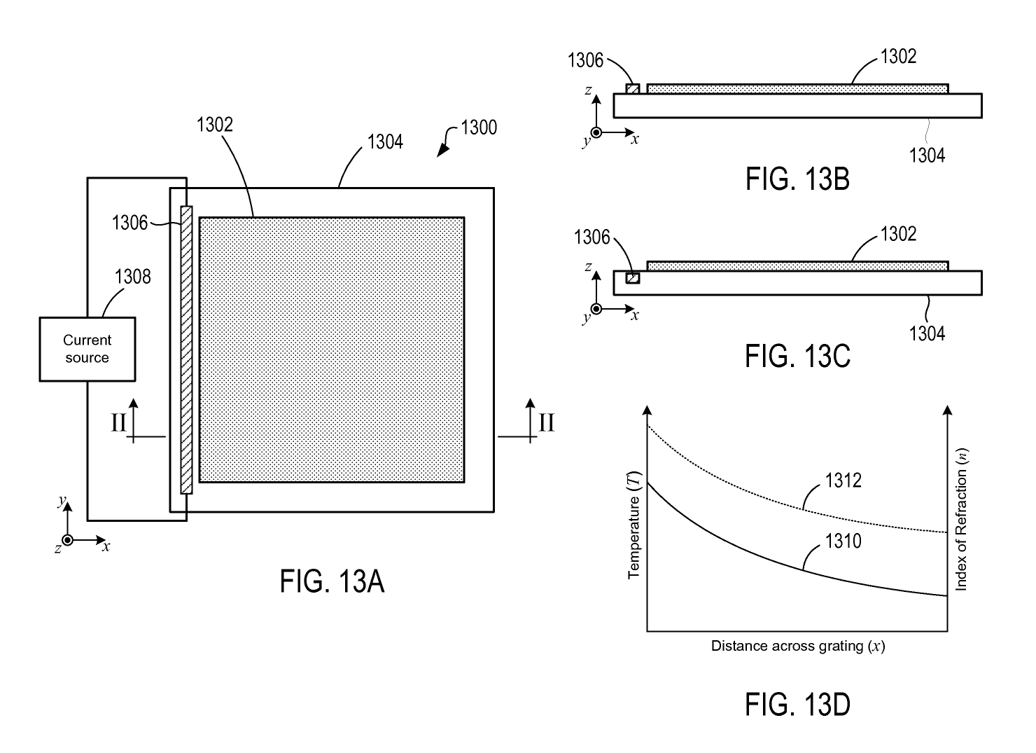

FIG. 13A shows a top view of an example thermally controlled optical system 1300. The system 1300 includes a SWG 1302 disposed on a surface of a substrate 1304. The substrate 1304 can represent the substrate of an optical system configured to reflect with a particular wavefront, as described above with reference to FIG. 1, or the substrate 1304 can represent the low refractive index cavity material of an optical system configured to transmit light with a particular wavefront, as described above with reference to FIG. 6. The SWG 1302 can be a one- or two-dimensional grating pattern composed of a relatively higher refractive index material than the substrate 1304. The system 1300 includes a single heating element 1306 electronically connected to a current source 1308. The heating element 1306 is composed of a material that converts electrical current supplied by the current source 1308 into radiant heat in a process called Joule heating. In certain examples, the element 1306 can be composed of a p-type semiconductor or an n-type semiconductor and can include electrical contacts (not shown) located at opposite ends of the element 1306. The electrical contacts can be composed of a metal, such as gold, silver, platinum, copper, or another suitable conductor. In other examples, the electrical contacts can be omitted and the element 1306 can be composed of platinum, nichrome, silicon carbide, molybdenum disilicide, or another suitable metal or alloy that through resistance converts electrical current into heat. The heating element 1306 can be disposed on the substrate 1304 or embedded within the substrate 1304. FIG. 13B shows a cross-sectional view of the system 1300 along a line II-II, shown in FIG. 13A, in which the heating element 1306 is disposed on the substrate 1304 surface adjacent to the SWG 1302. FIG. 13C shows a cross-sectional view of the system 1300 along the line II-II in which the heating element 1306 is embedded within the substrate 1304 adjacent to the SWG 1302. The heating element 1302 can be used to heat the SWG in the x-direction across the SWG 1302. FIG. 13D shows an example plot of temperature and the index of refraction in the x-direction across the SWG 1302. Curves 1310 and 1312 represent the temperature and corresponding index of refraction decrease in the x-direction across the SWG 1302 and indicate that much of the heating of the SWG 1302 occurs near the element 1306.

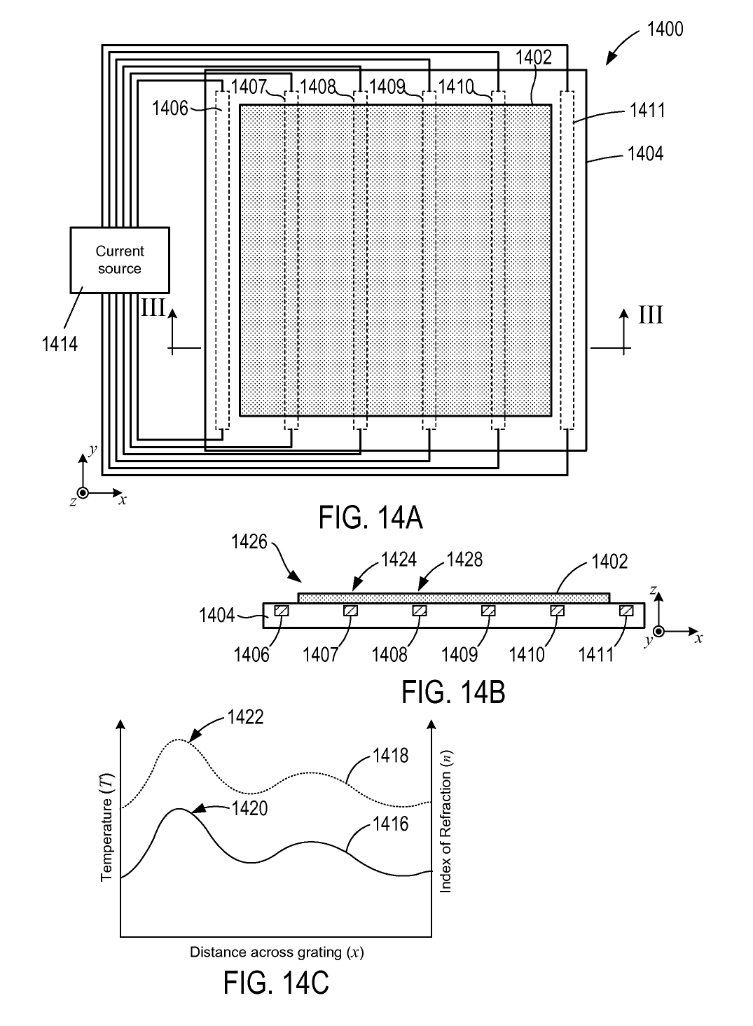

FIG. 14A shows a top view of an example thermally controlled optical system 1400. The system 1400 includes a SWG 1402 disposed on a surface of a substrate 1404. The SWG 1402 can be a one- or two-dimensional grating pattern composed of a relatively higher refractive index material than the substrate 1404, as described above. The substrate 1404 represents the substrate of a reflective optical system or the transparent cavity material of a transmissive optical system. The system 1400 includes a six heating elements 1406-1411 embedded within the substrate 1404. Each heating element is separately connected to a current source 1414. FIG. 14B shows a cross-sectional view of the system 1400 along the line III-III, shown in FIG. 14A. The heating elements can be used to selectively heat different regions of the SWG 1402 in the x-direction. FIG. 14C shows an example plot of temperature and index of refraction in the x-direction across the SWG 1402. Curves 1416 and 1418 represent the temperature and corresponding index of refraction of the SWG 1402. For example, peaks 1420 and 1422 of the curves 1416 and 1418 reveal that by applying a relatively larger current to heating element 1407 than to neighboring heating elements 1406 and 1408, the index of refraction of a region 1424 is larger than for neighboring regions 1426 and 1428 of the SWG 1402.

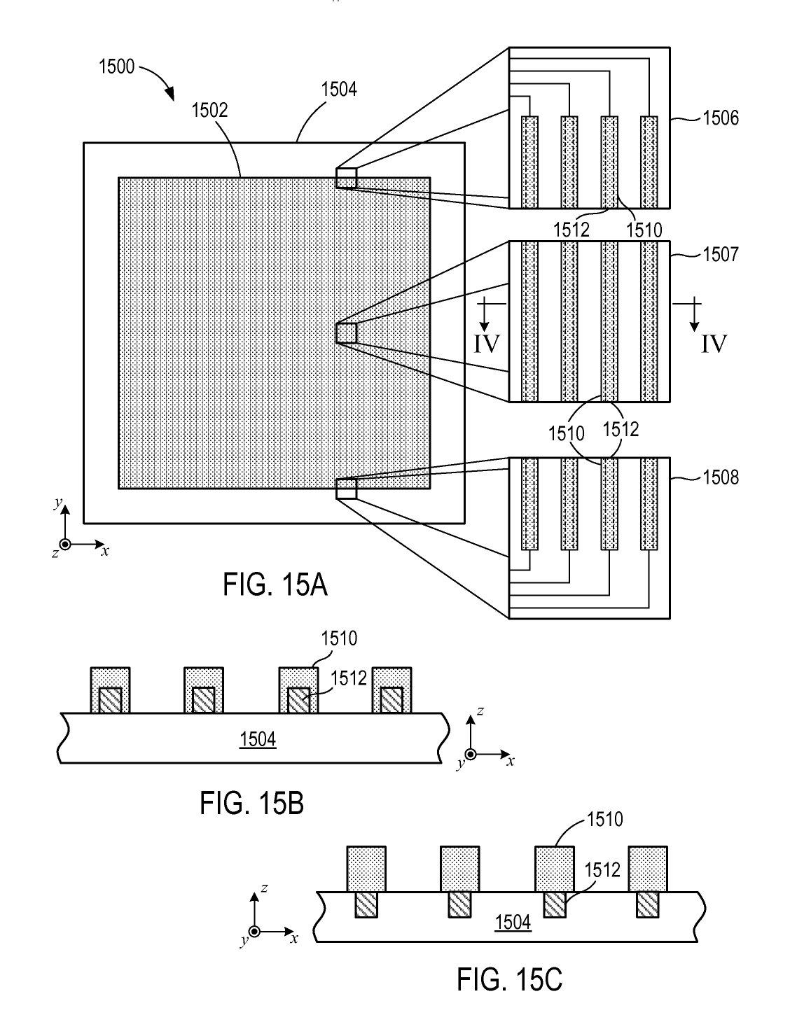

Note that optical systems are not intended to be limited to 1 or 6 heating elements to dynamically control the refractive index of a SWG. The number of heating elements can range from as few as one to more than six, depending on the level of refractive index fine tuning desired. Control over the refractive index of a one-dimensional SWG can be refined even further by providing a heating element for each line of the SWG. FIG. 15A shows a top view of an example thermally controlled optical system 1500 with a one-dimensional SWG 1502 disposed on a substrate 1504. FIG. 15A includes three magnified views 1506-1508 of the same four lines of the SWG 1502. Each line has an associated heating element that extends the length of the line in the y-direction is separately connected to a current source (not shown). For example, line 1510 has an associated heating element 1512 that extends the length of the line 1510. The heating elements can be embedded within each line of the SWG 1502, or the heating elements can be embedded within the substrate 1504 beneath each line of the SWG 1502. FIGS. 15B-15C show example cross-sectional views of the magnified view 1507, along a line IV-IV, shown in FIG. 15A. In FIG. 15B, the heating elements are embedded within the lines, and in FIG. 15C, the heating elements are embedded within the substrate 1504 beneath the lines.

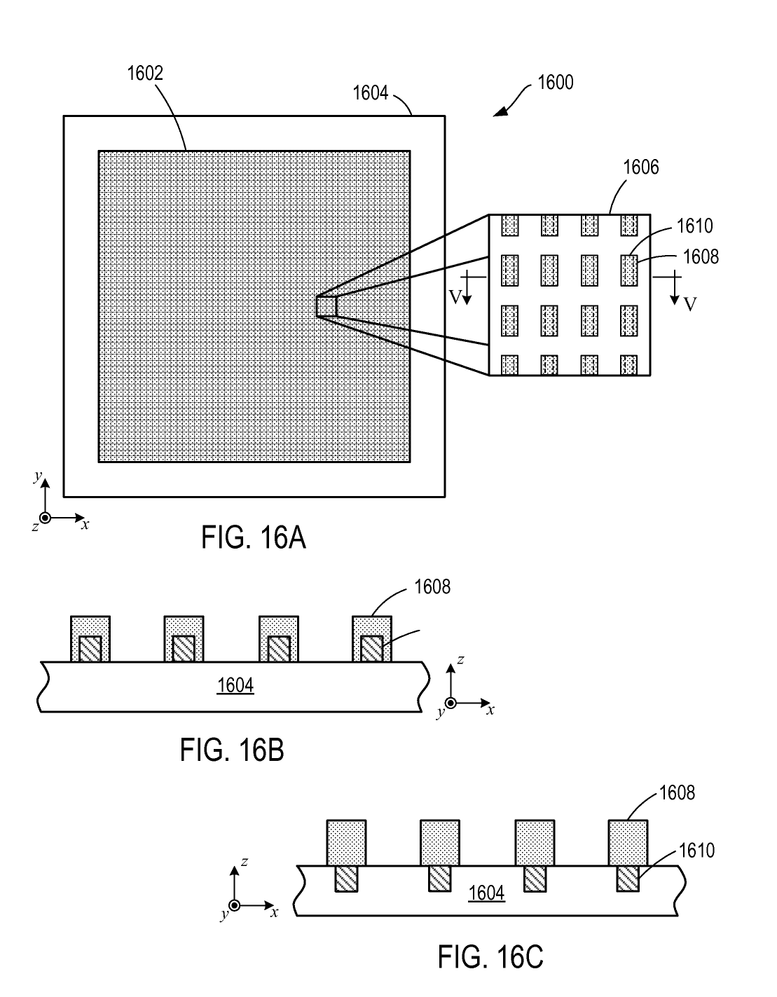

Control over the refractive index of a two-dimensional SWG can be refined by providing a heating element for each post of the SWG. FIG. 16A shows a top view of an example thermally controlled optical system 1600 with a two-dimensional SWG 1602 disposed on a substrate 1604. FIG. 16A includes a magnified view 1606 of posts of the SWG 1602. Each post has an associated heating element that is separately connected to a current source (not shown). For example, post 1608 has an associated heating element 1610. The heating elements can be embedded within each post of the SWG 1602, or the heating elements can be embedded within the substrate beneath each post of the SWG 1602. FIGS. 16B-16C show example cross-sectional views of the magnified view 1606, along a line V-V, shown in FIG. 16A. In FIG. 16B, the heating elements are embedded within the post, and in FIG. 16C, the heating elements are embedded within the substrate 1604 beneath the posts.

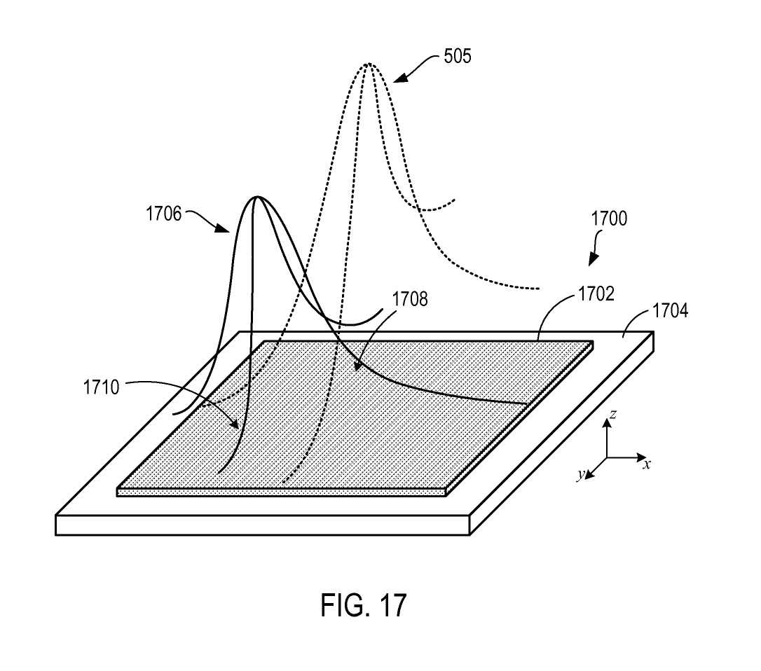

A thermally controlled optical system can be operated to dynamically change the reflective or transmissive phase front associated with a SWG by changing the refractive index over various regions of the SWG. FIG. 17 shows an example of a thermally controlled optical system 1700. The system 1700 includes a SWG 1702 disposed on a substrate 1704 and includes heating elements (not shown). In the example of FIG. 17, the SWG 1702 is configured with the same grating pattern as the reflective SWG 504 described above with reference to FIG. 5. As a result, when no current is applied to the heating elements of the system 1700, the SWG 1702 produces the contour map 505 represented by dashed line curves. On the other hand, contour plot 1706 represents one possible phase front associated with applying particular currents to heating elements of the system 1700. The phase front represented by the contour plot 1706 shows how the region 1708 of the SWG 1702 responsible for applying the largest phase shift to reflected light when no current is applied is shifted to the region 1710 for a particular heating of the heating element.

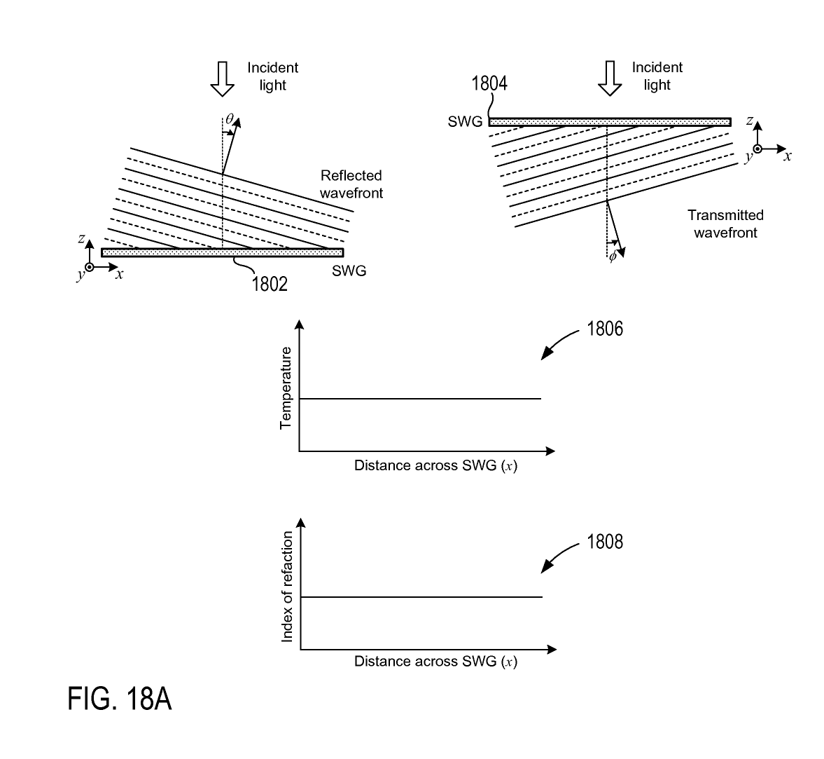

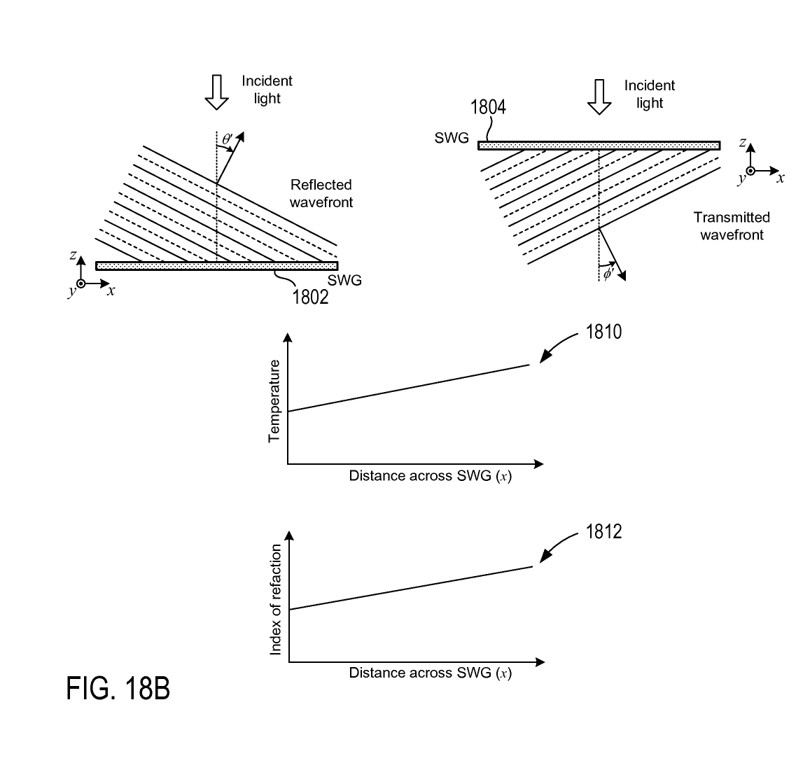

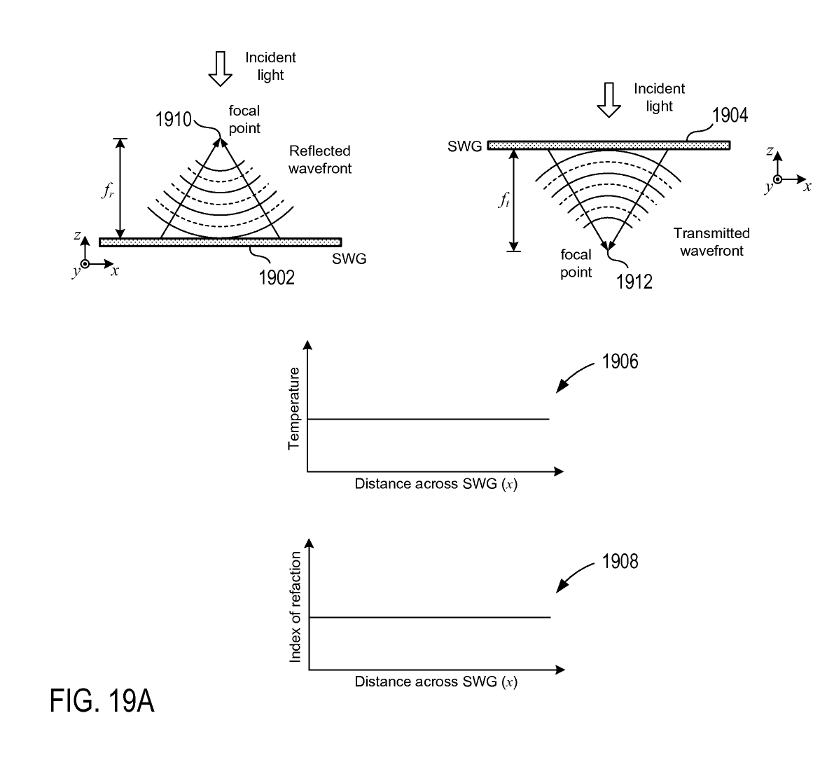

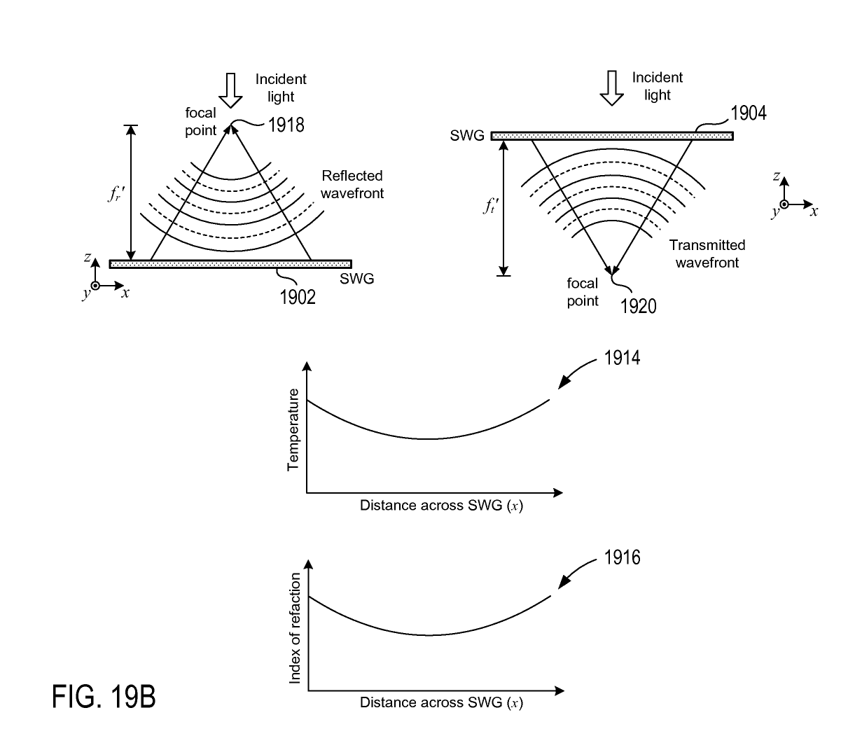

A thermally controlled optical system can be operated to steer a reflected or transmitted beam of light, change the focal point of a reflected or transmitted beam of light, or correct the phase front of a reflected or transmitted beam of light. FIGS. 18 and 19 represent just four examples of how thermally controlled optical systems can be operated to change the optical properties of the optical systems and are not intended to be exhaustive of limit the manner in which thermally controlled optical systems can be operated.

FIGS. 18A-18B show side views of two examples of thermally controlled optical systems operated to steer reflected and transmitted beams of light, respectively. A first optical system includes a SWG 1802 and at least one heating element (not shown) and can be operated to control the angle of reflection of a reflected beam of light. A second optical system includes a SWG 1804 and at least one heating element (not shown) and can be operated to control the angle of transmission of a transmitted beam of light. In FIG. 18A, initially, the temperature and the index of refraction are constant across the SWGs 1802 and 1804, as indicated by temperature plot 1806 and index of refraction plot 1808. SWG 1802 receives a beam of light with normal incidence and reflects the beam with an angle of reflection θ, and SWG 1804 receives a beam of light with normal incidence and transmits the beam with an angle of transmission 0. In FIG. 18B, a temperature gradient represented by plot 1810 is applied to the SWGs 1802 and 1804, which produces a corresponding gradient in the index of refraction represented by plot 1812. As a result, the SWG 1802 receives a beam of light with normal incidence and reflects the beam with a larger angle of reflection θ′ (i.e., θ<θ′), and the SWG 1804 receives a beam of light with normal incidence and transmits the beam with a larger angle of transmission φ′ (i.e., φ<φ′).

FIGS. 19A-19B show side views of two examples of thermally controlled optical systems operated to focus reflected and transmitted beams of light, respectively. A first optical system includes a SWG 1902 and at least one heating element (not shown) and can be operated to control the location of the focal point of a reflected beam of light. A second optical system includes a SWG 1904 and at least one heating element (not shown) and can be operated to control the location of a focal point of a transmitted beam of light. In FIG. 19A, initially, the temperature and the index of refraction across the SWGs of the SWGs 1902 and 1904 are constant, as indicated by temperature plot 1906 and index of refraction plot 1908. SWG 1902 receives a beam of light with normal incidence and reflects the beam to a focal point 1910 with focal length fᵣ. SWG 1904 receives a beam of light with normal incidence and focuses the transmitted beam to a focal point 1912 with focal length fₜ. In FIG. 19B, a temperature gradient represented by plot 1914 is applied to the SWGs 1902 and 1904, which produces a corresponding gradient in the index of refraction represented by plot 1916. The change in the effective refractive index indicated by plot 1916 increases the focal lengths of the SWGs 1902 and 1904. As a result, the SWG 1902 reflects the beam to a focal point 1918 with focal length fᵣ′, where fᵣ<fᵣ′, and the system 1902 transmits the beam to a focal point 1920 with focal length fₜ′, where f<f′.

Note that the focal points 1918 and 1920 are located over the approximate center of the SWGs 1902 and 1904. The focal points 1918 and 1920 can also be shifted to one side by asymmetrically heating the SWGs 1902 and 1904.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. An optical system comprising:
a sub-wavelength grating having a planar geometry and a grating pattern associated with a particular shape of, and direction in which, a wavefront is to emerge from the grating, when the grating is illuminated by a beam of light; and
at least one heating element separately connected to a current source, the current source to inject a current into each heating element to heat a corresponding region of the grating and to produce a desired change in the shape of, and/or direction in which, the wavefront is to emerge from the grating.

2. The optical system of claim 1, further comprising a substrate, wherein the grating is disposed on a planar surface of the substrate and the grating is composed of a material having a relatively higher refractive index than the refractive index of the substrate.

3. The optical system of claim 2, wherein the at least one heating element is embedded within the substrate.

4. The optical system of claim 1, wherein the at least one heating element is embedded within the sub-wavelength grating.

5. The optical system of claim 1, wherein the sub-wavelength grating further comprises a planar membrane in which the grating pattern is formed.

6. The optical system of claim 1, wherein the grating pattern further comprises a one-dimensional pattern of lines separated by grooves.

7. The optical system of claim 1, wherein the grating pattern further comprises a two-dimensional pattern of posts separated by grooves.

8. The optical system of claim 1, wherein the grating pattern further comprise a two- dimensional pattern of holes.

9. The optical system of claim 1, wherein the wavefront is to emerge from the grating further comprises the wavefront is to be reflected from the grating.

10. The optical system of claim 1, wherein the wavefront is to emerge from the grating further comprises the wavefront is to be transmitted through the grating.

11. A method to change the interaction of light with a planar, sub-wavelength grating, the method comprising:
illuminating the sub-wavelength grating, the grating having a grating pattern to cause light to emerge from the grating with a particular wavefront shape and direction; and
heating selected regions of the grating to produce a desired change in the shape of, and/or direction in which, the wavefront is to emerge from the grating.

12. The method of claim 11, wherein heating selected regions of the grating further comprises injecting current into at least one heating element embedded within a substrate upon which the grating is disposed.

13. The method of claim 11, wherein heating the selected regions of the grating further comprises injecting current into at least one heating element embedded with the grating.

14. The method of claim 11, wherein heating the selected regions of the grating further comprises changing the effective refractive index of the grating

15. The method of claim 11, wherein heating the selected regions of the grating further comprises changing in the volume of the grating.

16. The method of claim 11, wherein illuminating the grating further comprising illuminating the grating with TM polarized light.

17. The method of claim 11, wherein illuminating the grating further comprise illuminating the grating with unpolarized light.

18. The method of claim 11, wherein the grating pattern further comprises a one-dimensional pattern or a two-dimensional grating pattern.

19. The method of claim 11, wherein the wavefront is to emerge from the grating further comprises the wavefront is to be reflected from the grating.

20. The method of claim 11, wherein the wavefront is to emerge from the grating further comprises the wavefront is to be transmitted through the grating.
